(19) United States
(12) Patent Application Publication
(10) Pub. No.: US 2011/0260719 A1
(43) Pub. Date: Oct. 27, 2011

(54) ROTATIONAL ANGLE SENSORS AND MANUFACTURE METHODS THEREOF

(75) Inventors: Makoto MASE, Handa-shi (JP); Tsutomu IKEDA, Tokoname-shi (JP)

(73) Assignee: AISAN KOGYO KABUSHIKI KAISHA, Obu-shi (JP)

(21) Appl. No.: 13/089,432

(22) Filed: Apr. 19, 2011

(30) Foreign Application Priority Data
Apr. 22, 2010 (JP) 2010-098731

(51) Int. Cl. G01B 7/30; B29C 65/42

(52) U.S. Cl. 324/207.25; 264/46.5

(57) ABSTRACT

A rotational angle sensor has a molded body made of a resin and having a substantial cylinder shape with a center axis, and a conversion IC buried in the molded body and having a magnetic sensing portion, a computing portion and leads connecting the magnetic sensing portion with the computing portion. The magnetic sensing portion is disposed nearly perpendicular to the center axis of the molded body. The leads are bent such that the computing portion is disposed parallel to the center axis of the molded body and that a connection between one of the lead and the computing portion is positioned closer to the center axis of the molded body than a radially outer end of the lead.

### CROSS-REFERENCES TO RELATED APPLICATIONS

This application claims priority to Japanese patent application No 2010-98731, the components of which are incorporated herein by reference.

### BACKGROUND OF THE INVENTION

1. Field of the Invention

The present disclosure relates to rotational angle sensors and manufacture methods thereof.

2. Description of the Related Art

A throttle controller configured to control pivot of a throttle valve of a gas vehicle includes a noncontacting rotational angle sensor for sensing magnetic force in order to measure a rotation angle of the throttle valve. The conventional rotational angle sensor has a molded body having a substantial cylinder shape and a plurality of terminals extending from a bottom surface of the molded body. The molded body contains therein a pair of conversion ICs each having a magnetic sensing portion for detecting a direction of the magnetic force, a computing portion for converting signals output from the magnetic sensing portion into rotation angle signals, leads connecting the magnetic sensing portion with the computing portion, and lead terminals connecting the computing portion with the terminals.

In order to detect rotation angle of a throttle gear pivoting about its rotation axis together with the throttle valve, it is necessary to position the magnetic sensing portions on and vertical to the rotation axis. Thus, the leads of each conversion IC are bent in L-shape such that the magnetic sensing portion is nearly perpendicular to the computing portion. In addition, because it is necessary to dispose the rotational angle sensor within a relatively-small magnetic space defined in the throttle gear, the rotational angle sensor is configured to have a smaller diameter.

Japanese Laid-Open Patent Publication No. 2007-92608 discloses an intake controller having a pair of conversion ICs disposed on a holder projecting upwardly and made of a resin, and a molded body covering the conversion ICs. Each of the conversion ICs has a magnetic sensing portion, a computing portion, and leads connecting the magnetic sensing portion with the computing portion and bent in an L-shape such that the magnetic sensing portion is vertical to the computing portion. Japanese Laid-Open Patent Publication No. 2008-8754 discloses a method for manufacturing a rotational angle sensor. The method has steps for bending leads connecting a magnetic sensing portion with a computing portion in an L-shape such that the magnetic sensing portion is vertical to the computing portion, disposing a pair of the conversion ICs in a cavity formed in a mold, and injecting a resin into the cavity. Japanese Laid-Open Patent Publication No. 2008-145258 discloses a method for manufacturing a rotational angle sensor. The method has steps for bending the leads connecting the magnetic sensing portion with the computing portion in an L-shape such that the magnetic sensing portion is vertical to the computing portion, disposing a pair of the conversion ICs on a holder and form a molded body from a resin such that the holder and the conversion ICs are buried in the molded body.

There has been a need in the art for an improved rotational angle sensor and an improved manufacture method thereof.

### SUMMARY OF THE INVENTION

In one aspect of this disclosure, a rotational angle sensor has a molded body made of a resin and having a substantial cylinder shape with a center axis, and a conversion IC buried in the molded body and having a magnetic sensing portion, a computing portion and leads connecting the magnetic sensing portion with the computing portion. The magnetic sensing portion is disposed nearly perpendicular to the center axis of the molded body. The leads are bent such that the computing portion is disposed parallel to the center axis of the molded body and that a connection between one of the lead and the computing portion is positioned closer to the center axis of the molded body than a radially outer end of the lead.

In accordance with this aspect, the magnetic sensing portion is positioned nearly perpendicular to the computing portion, and the connection between one of the lead and the computing portion is closer to the center axis of the molded body (corresponding to a rotation axis ZS) than the radially outer end of the lead as shown in FIG. 7, so that a distance between the center axis of the molded body and an outer edge of the computing portion can be shorter than that in the conventional rotational angle sensor where the leads are bent in the L-shape.

In another aspect of this disclosure, a method for manufacturing a rotational angle sensor including a molded body made of a resin, and a conversion IC buried in the molded body and having a magnetic sensing portion, a computing portion and leads connecting the magnetic sensing portion with the computing portion has bending the leads such that the magnetic sensing portion is positioned nearly perpendicular to the computing portion, mounting the conversion IC onto a lower mold having a projection with guide grooves such that the magnetic sensing portion fits with the guide grooves, covering the lower mold with an upper mold defining a cavity such that the lower mold and the conversion IC are placed in the cavity, and filling the cavity with the resin for the molded body.

In accordance with this aspect, because the guide grooves are provided to the projection of the lower mold, an operator can easily and efficiently fit the magnetic sensing portion with the guide grooves in order to mount the conversion IC onto the lower mold.

### BRIEF DESCRIPTION OF THE DRAWINGS

In the accompanying drawings:

FIG. 1 is a cross sectional view of a throttle controller having a rotational angle sensor of this disclosure;

FIG. 2 is a perspective view of a sensor cover;

FIG. 3A-C are views showing the rotational angle sensor provided with interconnection terminals;

FIG. 4A-C are views showing an outer appearance of the rotational angle sensor;

FIG. 5A is a top view of a throttle gear;

FIG. 5B is a view showing relationship between the throttle gear and the rotational angle sensor;

FIG. 6A is a perspective view of a conversion IC before its leads are bent;

FIGS. 6B and 6C are views showing the conversion IC after the leads are bent;

FIG. 7 is a side view of the conversion IC where the leads are bent in a substantial S-shape;

FIG. 8A-D are views showing a process for bending the leads of the conversion IC;

FIGS. 9A and 9B are views showing an outer appearance of a lower mold having a projection;

FIG. 9C is a view showing a process for mounting the conversion ICs onto the lower mold;

FIG. 10A-C are views showing the lower mold provided with a pair of the conversion ICs;

FIG. 11A is a cross sectional view of an upper mold covering the lower mold;

FIG. 11B is a cross sectional view of the rotational angle sensor formed by using the lower mold in FIG. 9;

FIG. 12A-C are views showing another lower mold;

FIG. 13A is a side view showing the lower mold in FIG. 12, which is provided with a pair of the conversion ICs;

FIG. 13B is a cross sectional view of the rotational angle sensor formed by using the lower mold in FIG. 12; and

FIG. 14 is a view showing a magnetic hysteresis loop (B-H loop).

### DETAILED DESCRIPTION OF THE PREFERRED EMBODIMENTS

Each of the additional features and teachings disclosed above and below may be utilized separately or in conjunction with other features and teachings to provide improved rotational angle sensors and methods for manufacturing rotational angle sensors. Representative examples of the present disclosure, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

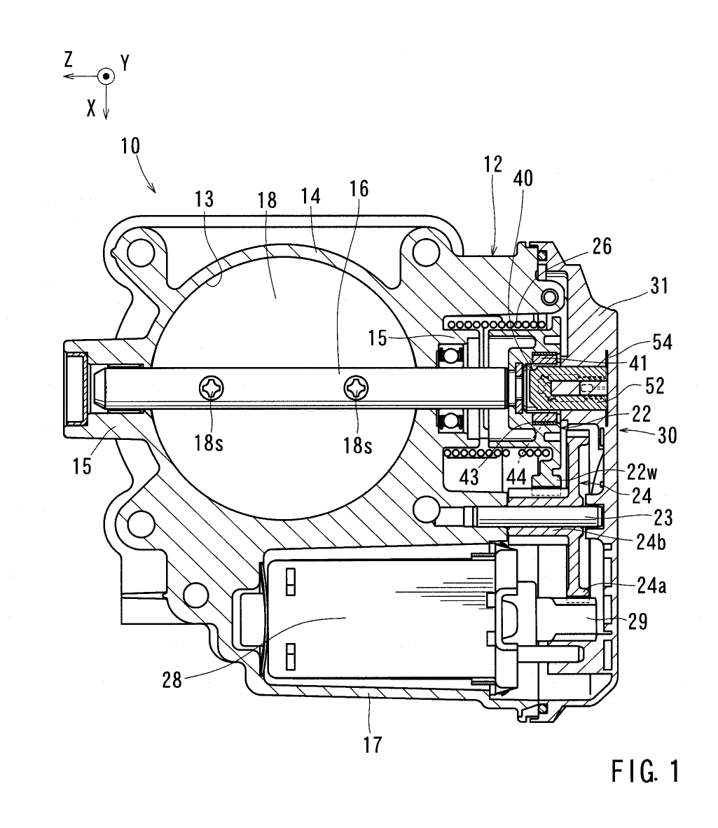

A first embodiment of this teaching will be described in reference to accompanying drawings. FIG. 1 is a cross sectional view of a throttle controller 10 having a rotational angle sensor 40. In each drawing, an X-axis, a Y-axis and a Z-axis are vertical to each other. The Z-axis is parallel to a rotational axis of a throttle valve 18, and the Y-axis is parallel to an axis of a bore 13 as shown in FIG. 1.

A whole structure of the computerized throttle controller 10 mounted on a gas vehicle such as automobile will be described based on directions shown in FIG. 1. In detail, the Z-axis direction corresponds to a horizontal direction, the X-axis direction corresponds to a vertical direction, and the Y-axis direction corresponds to a direction perpendicular to the drawing in FIG. 1.

As shown in FIG. 1, the throttle controller 10 has a throttle body 12 made of a resin and provided with various components. The throttle body 12 has a bore wall 14 defining the bore 13 that extends in the Y-axis direction and works as a pathway for intake air, a motor housing 17 housing a motor 28 that drives the throttle valve 18, and a gear housing at a right side. The bore wall 14 has bearings 15 opposite each other in the Z-axis direction and configured to rotatably support a metal throttle shaft 16 that passes through the bore 13 in a radial direction (the Z-axis direction). The throttle valve 18 is formed in a circular plate shape and is fixed on the throttle shaft 16 by screws 18s such that the throttle valve 18 works as butterfly valve for the bore 13. The throttle valve 18 pivots together with the throttle shaft 16 in order to open and close the bore 13.

The throttle shaft 16 is coaxially and fixedly provided with a throttle gear 22 at its right end such that the throttle shaft 16 (i.e. throttle valve 18) pivots together with the throttle gear 22. Between the throttle gear 22 and the throttle body 12, a back spring 26 consisting of a coil spring is provided such that the back spring 26 biases the throttle gear 22 in a closing direction.

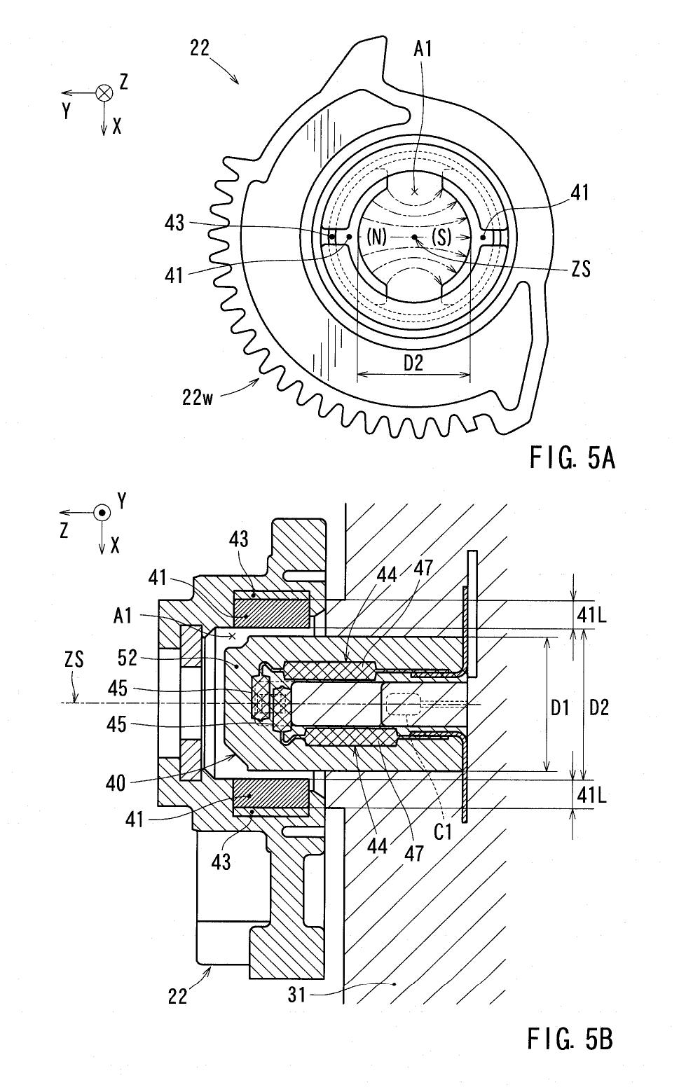

The motor housing 17 is formed in a hollow cylinder shape positioned parallel to the throttle shaft 16 and having a closed end at its left end and an opening at a right end. The motor housing 17 stores a motor 28 such as a DC motor therein. The motor 28 works depending on driving signals, which are output from an engine controller (not shown) based on an angle of an accelerator pedal or the like. The motor 28 has an output shaft extending rightward and having a pinion gear 29 at an end thereof. The pinion gear 29, a counter gear 24, and the throttle gear 22 are mounted on the right side of the throttle body 12 such that the pinion gear 29, a counter gear 24, and the throttle gear 22 can rotate about their parallel rotation axes, respectively. The counter gear 24 has a large diameter gear portion 24a meshing with the pinion gear 29 and a small diameter gear portion 24b meshing with a gear portion 22w of the throttle gear 22 (refer to FIG. 5A).

The pinion gear 29, the counter gear 24 and the throttle gear 22 constitute a reduction gear system such that normal rotation or reverse rotation of the pinion gear 29 is transmitted to the throttle gear 22 via the counter gear 24 in order to make the throttle shaft 16 pivot in a normal direction (the throttle valve 18 opens the bore 13) or in a reverse direction (the throttle valve 18 closes the bore 13). The rotational angle sensor 40 for sensing rotation angle of the throttle gear 22 is provided on the rotation axis of the throttle gear 22 (at a right side of the throttle gear 22 in FIG. 1). The right side of the throttle body 12 is provided with a sensor cover 30 configured to cover the rotational angle sensor 40, throttle gear 22, the counter gear 24 and the pinion gear 29.

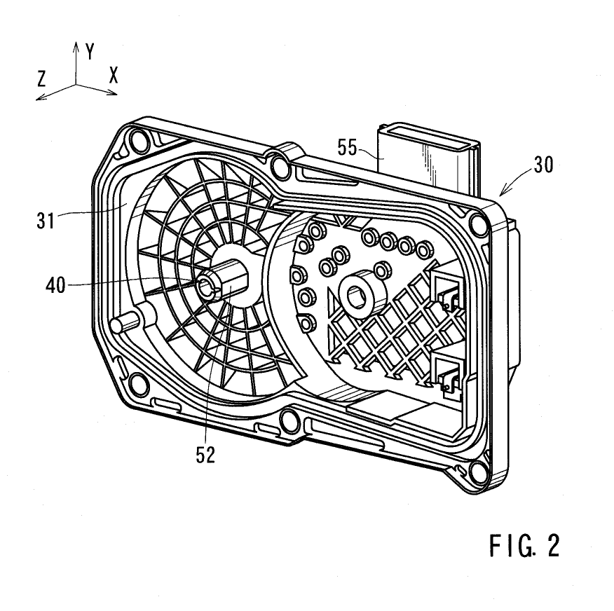

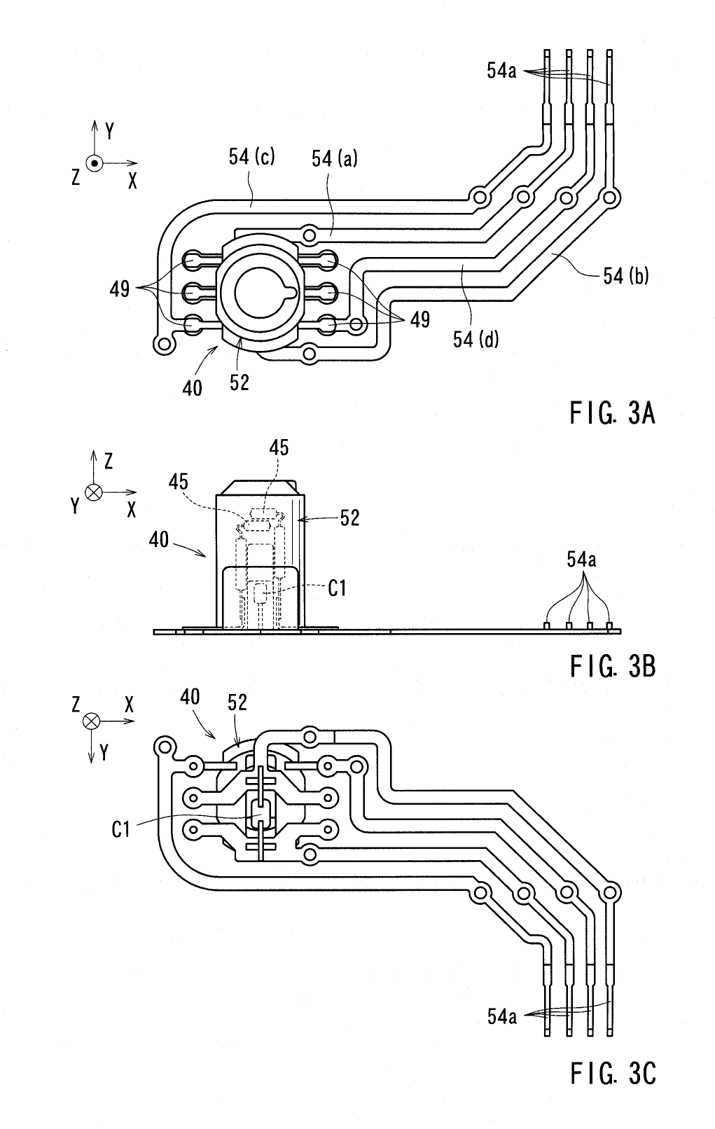

Next, an outer shape of the sensor cover 30 will be described in reference to FIG. 2. FIG. 2 is a perspective view of the sensor cover 30, which shows an inner side of the sensor cover 30 (left side in FIG. 1). The sensor cover 30 has a cover body 31 that is made of a resin or the like and is integrated with the rotational angle sensor 40 formed in a substantial cylinder shape by insert molding. As shown in FIG. 2, the rotational angle sensor 40 protrudes from the inner side of the sensor cover 30. An end of the rotational angle sensor 40 is coaxially and loosely inserted into a magnetic space A1 defined by the throttle gear 22 as shown in FIG. 1 and FIG. 5B. That is, the rotational angle sensor 40 does not contact with permanent magnets 41 and yoke 43 mounted on the throttle gear 22. The rotational angle sensor 40 is connected with interconnection terminals 54 as shown in FIG. 3A-C. The sensor cover 30 has a connector 55 for linking connecting portions 54a of the interconnection terminals 54 with another device.

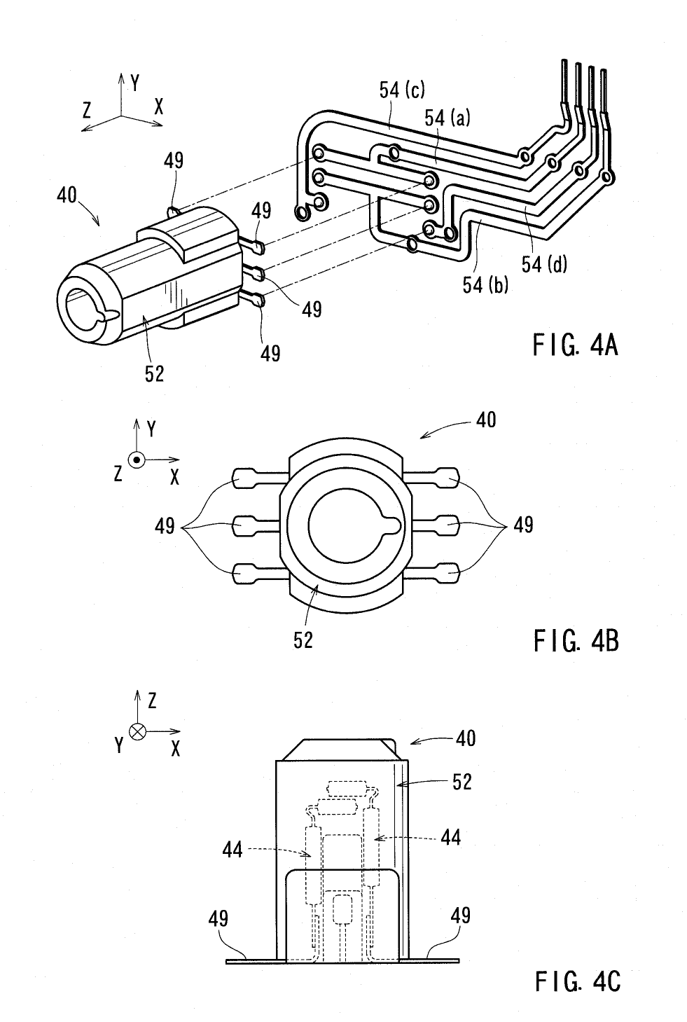

The rotational angle sensor 40 is formed in the substantial cylinder shape as shown in FIG. 4B and FIG. 4C and has a pair of conversion ICs 44, a molded body 52 made of a resin in a substantial cylinder shape, and terminals 49. The rotational angle sensor 40 detects alteration of magnetic field caused by pivot of the throttle gear 22 having field members and has the pair of the conversion ICs 44 in view of fail-safe such that when one of the conversion IC 44 breaks down, the rotational angle sensor 40 can ensure its detection ability due to the other conversion IC 44. As shown in FIG. 4A, the terminals 49 of the rotational angle sensor 40 are connected to the interconnection terminals 54, respectively. FIG. 3A-C show an outer appearance of the rotational angle sensor 40 connected with the interconnection terminals 54. FIG. 3B and FIG. 3C show an example where an electric device (for example, condenser) is inserted into a recess of the rotational angle sensor 40 and is connected with the interconnection terminals 54. As described below, because the rotational angle sensor 40 has the recess formed by a lower mold, such electric device to be connected with the interconnection terminals 54 can preferably housed in the recess in order to save space.

An outer appearance and a structure of the throttle gear 22 will be described in reference to FIG. 5A. FIG. 5A shows the throttle gear 22 viewed from a right side in FIG. 1. The throttle gear 22 pivots about a rotation axis ZS and defines the magnetic space A1, which is a cylindrical hollow space to receive the rotational angle sensor 40, around the rotation axis ZS (FIG. 5B). The throttle gear 22 has the cylinder shaped yoke 43 made of magnetic materials and a pair of the permanent magnets 41 (corresponding to field member) positioned inside the yoke 43. The yoke 43 and the permanent magnets 41 are integrally disposed around the magnetic space A1. The permanent magnets 41 face each and present a north pole and a south pole toward each other, respectively. Due to this configuration, the permanent magnets 41 generate lines of magnetic flux from the permanent magnet 41 presenting the N pole (left one in FIG. 5A) to the permanent magnet 41 presenting the S pole (right one in FIG. 5A) such that the lines of magnetic flux are perpendicular to the rotation axis ZS (shown by dashed lines in FIG. 5A).

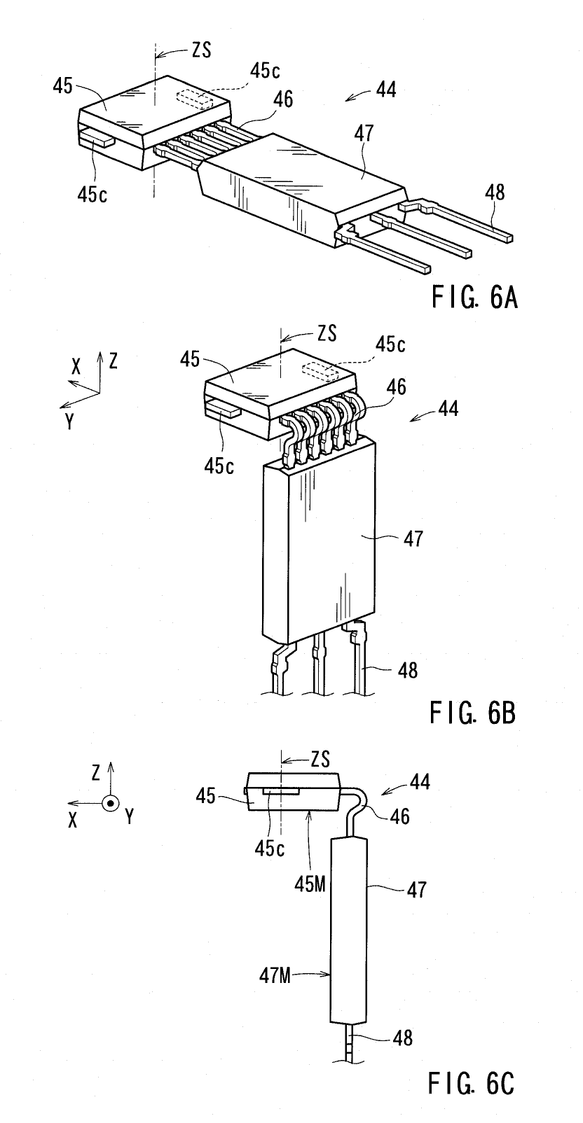

Next, positions of the throttle gear 22 and the rotational angle sensor 40 will be described in reference to FIG. 5B. FIG. 5B is a magnified view of a part of FIG. 1 for showing the positions of the throttle gear 22 and the rotational angle sensor 40. The rotational angle sensor 40 is formed in the substantial cylinder shape as shown in FIG. 4, and is inserted into the magnetic space A1 defined by the throttle gear 22 such that the rotational angle sensor 40 is positioned coaxially with the rotation axis ZS. The rotational angle sensor 40 has a pair of the conversion ICs 44 buried in the molded body 52. Each of the conversion ICs 44 has a magnetic sensing portion 45 for detecting alteration of magnetic field and outputting signals depending on the alteration, and a computing portion 47 for computing the signals from the magnetic sensing portion 45 and outputting rotation angle signals based on such computational result (FIG. 6). When the throttle gear 22 pivots about the rotation axis ZS from a position shown in FIG. 5B, a direction of the lines of magnetic flux changes. Then, in each conversion IC 44, the magnetic sensing portion 45 detects the changed direction of the lines of magnetic flux, and the computing portion 47 outputs the rotation angle signal depending on the changed direction of the lines of magnetic flux.

The permanent magnets 41 preferably generate a large number of lines of the magnetic flux (i.e., a higher magnetic flux density) for detecting rotation angle more stably and more correctly. For increasing lines of the magnetic flux, it is necessary to use permanent magnets 41 containing rare earthes and generating larger magnetic force, to use larger permanent magnets 41 in size, or to make the permanent magnets 41 closer to each other. As shown in FIG. 5B, in the throttle controller 10 of this embodiment, a distance (diameter D2 of the magnetic space A1) between the permanent magnets 41 is decreased and a thickness 41L of each permanent magnet 41 is increased (i.e., a larger permanent magnets 41 are used) in order to increase magnetic flux density. Thus, the diameter D2 of the magnetic space A1 becomes smaller, so it is necessary to reduce a diameter D1 of the rotational angle sensor 40. However, it is difficult to reduce the size of the magnetic sensing portion 45 of the conversion IC 44 disposed in the rotational angle sensor 40. Therefore, the diameter D1 of the rotational angle sensor 40 is decreased by changing curved shape of the leads 46 between the magnetic sensing portion 45 and the computing portion 47 in order to reduce the diameter D1 of the rotational angle sensor 40.

Next, an outer shape of the conversion IC 44 will be described in reference to FIG. 6. The conversion IC 44 of this disclosure is an existing product and is composed of the magnetic sensing portion 45 having a flattened box shape and configured to detect alteration of magnetic field and to output signals depending on such alteration, and the computing portion 47 having a flattened box shape and configured to compute the signals from the magnetic sensing portion 45 and to output the rotation angle signals based on such computational result (i.e., alteration of the magnetic field). The leads 46 made of conductive materials connect a side surface of the magnetic sensing portion 45 and a side surface of the computing portion 47 such that the magnetic sensing portion 45, the leads 46 and the computing portion 47 are arranged in a liner fashion. In addition, the computing portion 47 is connected with lead terminals 48 each transmitting the rotation angle signals or providing electric power, etc.

The computing portion 47 contains a semiconductor circuit or the like, and computes the signals output from the magnetic sensing portion 45 depending on the direction of the magnetic flux and then outputs the rotation angle signal (voltage signal) varying in a linear fashion depending on the rotation angle (i.e., the direction of the magnetic flux). The magnetic sensing portion 45 has a positioning plate 45c made of metal materials and penetrating the magnetic sensing portion 45 such that both ends of the positioning plate 45c protrude from opposite side walls (facing in the Y-axis direction) of the magnetic sensing portion 45, respectively. The magnetic sensing portion 45 contains an impedance element such as MR element such that the impedance element is mounted on a center region of the positioning plate 45c. As shown in FIG. 5B, the magnetic sensing portion 45 is positioned in the magnetic space A1 such that a top surface and a bottom surface of the magnetic sensing portion 45 are vertical to the rotation axis ZS of the throttle gear 22 and the impedance element disposed in the magnetic sensing portion 45 (the center region of the positioning plate 45c) is on the rotation axis ZS. In addition, as shown in FIG. 6B and FIG. 6C, the leads 46 are bent such that a bottom surface 47M (the largest surface) of the computing portion 47 is nearly perpendicular to the bottom surface 45M (the largest surface) of the magnetic sensing portion 45. That is, the magnetic sensing portion 45 is disposed perpendicular to the rotation axis ZS (corresponding to a center axis of the rotational angle sensor 40 (the molded body 52)), and the computing portion 47 is disposed parallel to the rotation axis ZS.

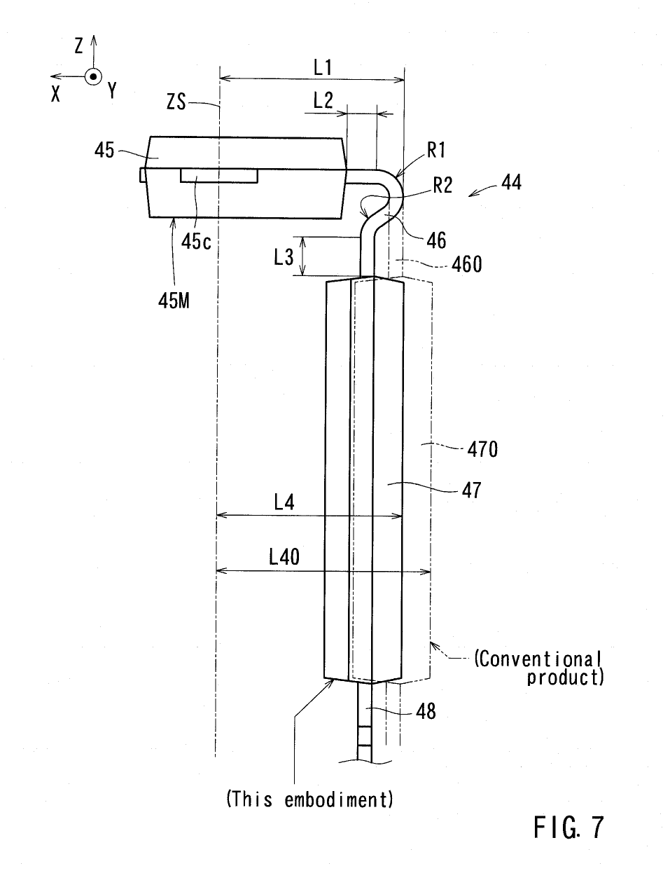

In the conventional throttle controllers, the leads are bent in the L-shape and have one curve section between the magnetic sensing portion and the computing portion. On the other hand, in this embodiment, the leads 46 have first and second curve sections R1 and R2 between the computing portion 47 and the magnetic sensing portion 45 as shown in FIG. 6 and FIG. 7. The leads 46 extending from the computing portion 47 are curved away from the rotation axis ZS at the second curve section R2 near the computing portion 47, and are curved in an opposite direction, i.e., toward the rotation axis ZS, at the first curve section R1. That is, the leads 46 are bent in a substantial S-shape. Here, the leads 46 are bent less than 90° at the first curve section R1, and a connection between the leads 46 and the computing portion 47 is positioned closer to the rotation axis ZS (corresponding to the center axis of the rotational angle sensor 40) than a radially outer end of the leads 46 (i.e., a right end of first curve section R1 in FIG. 7). Here, each of the leads 46 has a first straight end having a predetermined length L2 from the magnetic sensing portion 45 and a second straight end having a predetermined length L3 from the computing portion 47 as shown in FIG. 7. In addition, each of the curve sections R1 and R2 has curvature larger than a predetermined curvature. The rotational angle sensor 40 of this embodiment can decrease the diameter D1 due to the curved shape (shown by solid lines in FIG. 7) of the leads 46 compared with the conventional product having the curve section in the L-shape (shown by dashed lines in FIG. 7).

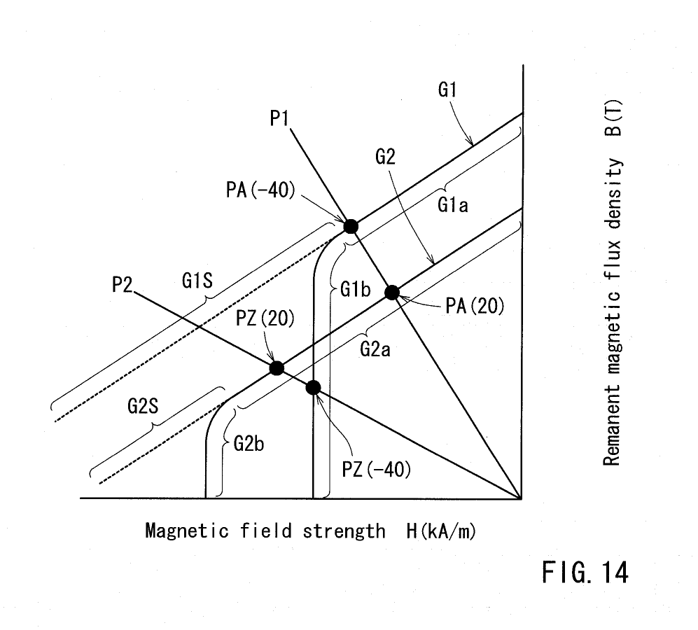

As shown in FIG. 7, when the center of the positioning plate 45c is positioned on the rotation axis ZS, the longest distance from the rotation axis ZS of this embodiment (i.e., the distance L1 between the rotation axis ZS and a radially outer end of the curve section R1 or the distance L4 between the rotation axis ZS and a radially outer edge (top surface) of the computing portion 47) is shorter than the longest distance in the conventional product (i.e., the distance L40). Accordingly, the diameter D1 of the rotational angle sensor 40 can be decreased compared with the conventional product due to configuration of the leads 46, so that it is able to reduce the distance (diameter D2) between the permanent magnets 41. Here, when the diameter D2 is decreased, a working point of each permanent magnet 41 on the B-H loop (magnetic hysteresis loop) becomes higher, that is, the permeance coefficient becomes larger (FIG. 14). Thus, use of the leads 46 bent in the S-shape can lead to increase in magnetic flux density, so that the throttle controller 10 detects the rotation angle more stably and more currently. In addition, because the distance (diameter D2) between the permanent magnets 41 are decreased, use of cheaper magnets or thinner magnets each having weaker magnetic force can maintain enough magnetic flux density required for the throttle controller 10. Therefore, it is able to reduce the cost for the throttle controller 10 or to make the throttle gear 22 smaller or lighter. On the contrary, because the distance (diameter D2) between the permanent magnets 41 is decreased, it is able to increase thickness 41L of each permanent magnet 41. In this case, the magnetic flux density can be increased, so that it is able to detect the rotation angle more stably and more correctly. Furthermore, in a case that the same permanent magnets as those of the conventional product are used, the working point of the permanent magnets becomes higher, so that it is able to generate higher magnetic flux density.

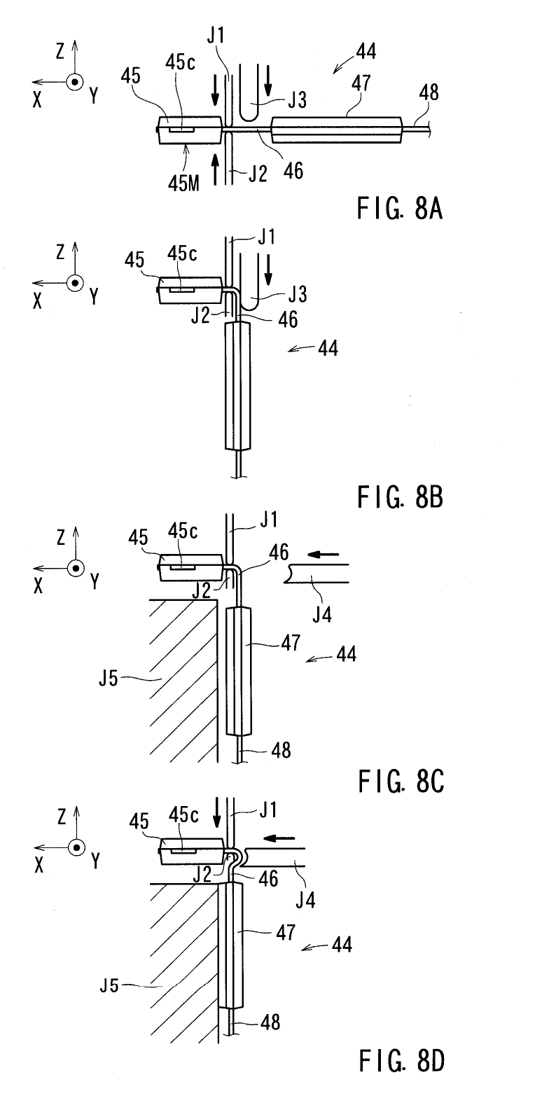

Next, processes for bending the leads 46 of the conversion IC 44 where the magnetic sensing portion 45, the leads 46, the computing portion 47 and the lead terminals 48 are arranged in a linear fashion into the substantial S-shape will be described in reference to FIG. 8A-D. Firstly, fixtures J1, J2 move in the Z-axis direction (a vertical direction to the bottom surface 45M of the magnetic sensing portion 45) toward each other and hold the leads 46 of the conversion IC 44 near the magnetic sensing portion 45 therebetween as shown in FIG. 8A. Then, as shown in FIG. 8A and FIG. 8B, fixture J3 moves toward the leads 46 along the fixture J1 and then presses the leads 46 in the Z-axis direction in order to partially shape the first curve section R1 of the leads 46 (FIG. 7). Then, as shown in FIG. 8C and FIG. 8D, fixture J4 having an outer shape corresponding to the second curve section R2 and a part of the first curve section R1 moves in the X-axis direction toward the leads 46 and presses the leas 46 in order to shape the curve sections R1 and R2 completely. Here, fixture J5 contacts with the bottom surface of the computing portion 47 for keeping the computing portion 47 at a predetermined position. In this way, it is able to easily bend the leads 46 of the conversion IC 44 into appropriate S-shape by use of the above-described processes and fixtures.

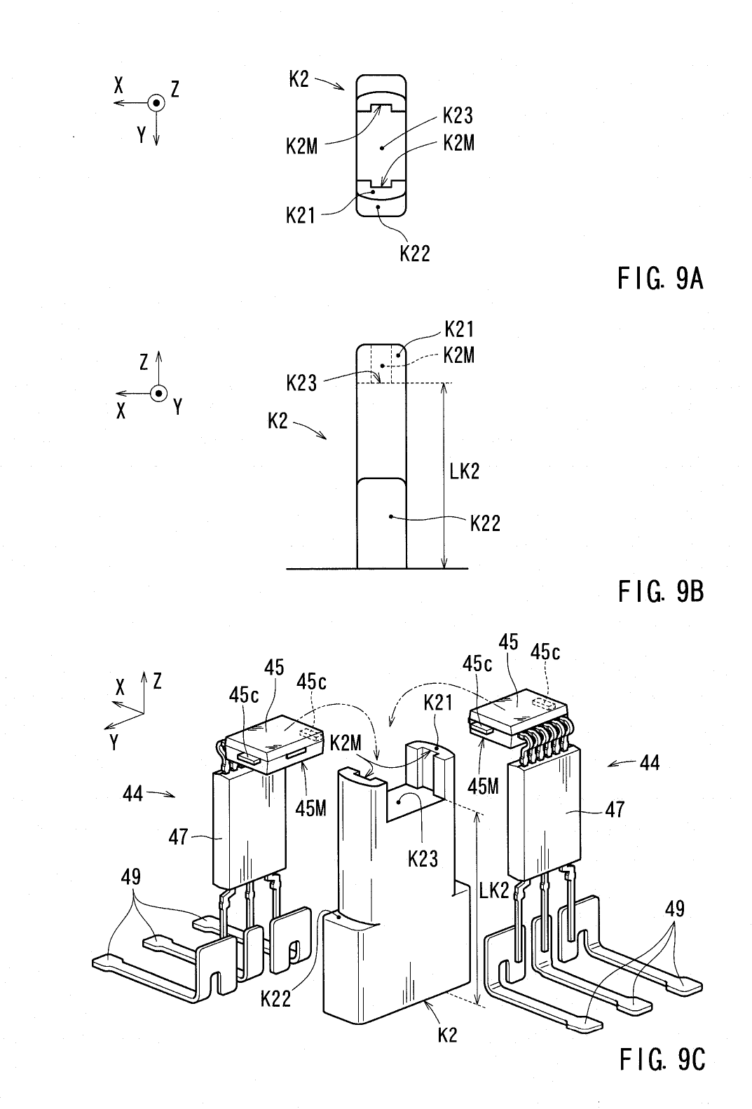

Manufacture methods (insert molding method) of the rotational angle sensor 40 containing a pair of the conversion ICs 44 integrated with the molded body 52 will be described in reference to FIG. 9 to FIG. 13. Here, the leads 46 of each conversion IC 44 are bent such that the bottom surface 45M of the magnetic sensing portion 45 is nearly perpendicular to the bottom surface 47M of the computing portion 47. And, the convention ICs 44 have the leads 46 bent in the S-shape and are connected with the terminals 49. Here, the methods described below can be applied to manufacture of a rotational angle sensor containing conversion ICs each having L-shaped leads.

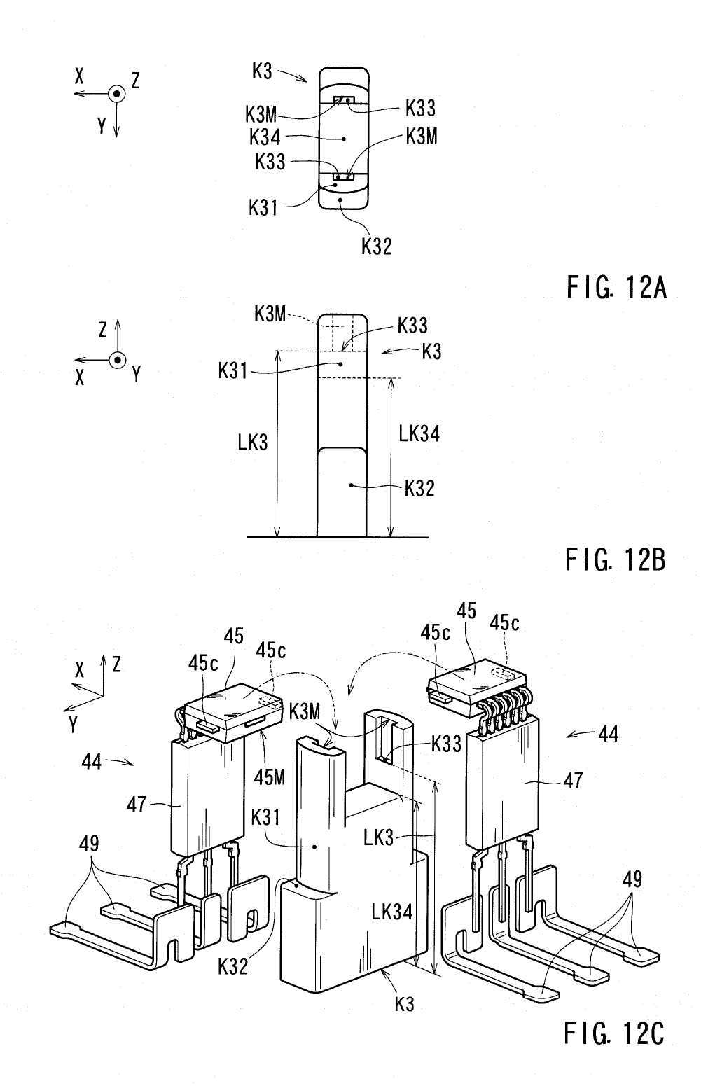

A first method for manufacturing the rotational angle sensor 40 will be described in reference to FIG. 9 to FIG. 11. The first method utilizes a lower mold K2 (FIG. 9A-C) different from a lower mold K3 (FIG. 12) of a second manufacture method. The first method for manufacturing the rotational angle sensor 40 includes steps for disposing a pair of the conversion ICs 44 on the lower mold K2, covering the conversion ICs 44 and the lower mold K2 with an upper mold K1 defining a cavity 52K, and injecting a resin into the cavity 52 K through an inlet In formed in the upper mold K1.

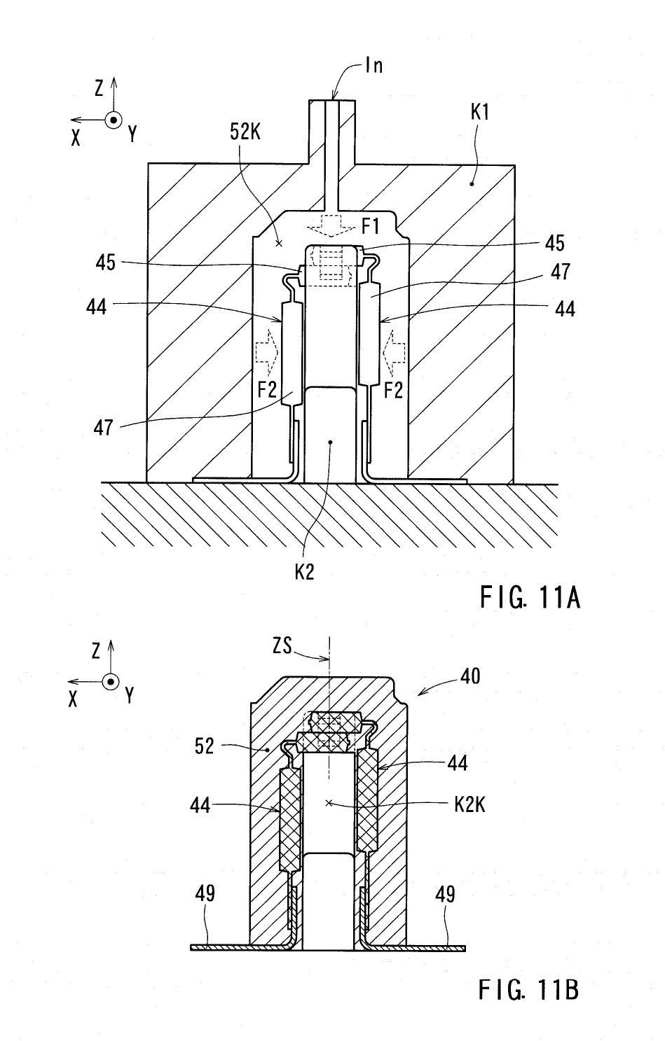

Firstly, an outer shape of the lower mold K2 will be described in reference to FIG. 9A-C. FIG. 9A is a top view of the lower mold K2. FIG. 9B is a front view of the lower mold K2. FIG. 9C is a perspective view showing the step for disposing the conversion ICs 44 on the lower mold K2. The lower mold K2 is configured to form a recess K2K of the molded body 52 (refer to FIG. 11B) and has a projection extending upwardly. The lower mold K2 has at an upper end of the projection guide grooves K2M extending in the vertical direction (the Z-axis direction in FIG. 9C) for guiding the positioning plates 45c of the conversion ICs 44. The lower mold K2 has a positioning surface K23 extending perpendicular to the Z-axis and below the guide grooves K2M and being configured to position the bottom surface 45M of one of the magnetic sensing portions 45 (left one in FIG. 9C). The positioning surface K23 is positioned at a predetermined distance LK2 from a lower end of the lower mold K2 in the Z-axis direction.

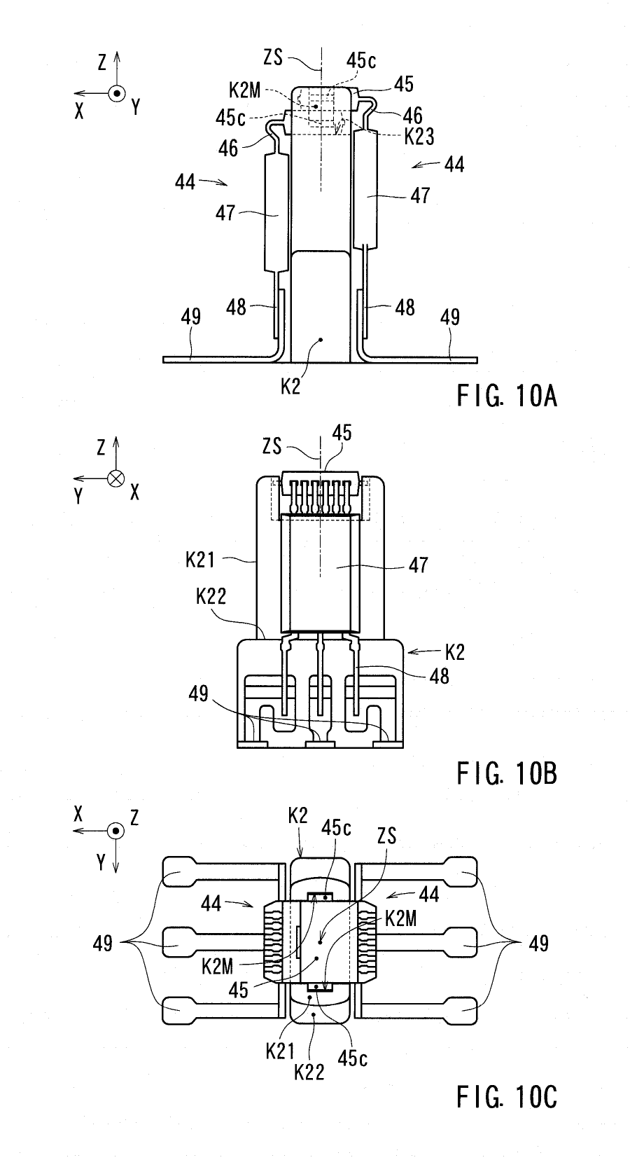

Next, the lower mold K2 provided with a pair of the conversion ICs 44 will be described in reference to FIG. 10A-C. FIG. 10A is a front view of the lower mold K2 provided with the conversion ICs 44, and FIG. 10B and FIG. 10C are a side view and a top view of the same, respectively. As shown in FIG. 10A-C, the guide grooves K2M fit with the positioning plate 45 in order to position the positioning plate 45c (i.e., the magnetic sensing portion 45) of each conversion IC 44 in the X-axis direction and the Y-axis direction. And, the positioning surface K23 contacts with the bottom surface of the magnetic sensing portion 45 of the lower conversion IC 44 (left one in FIG. 10A) such that the magnetic sensing portion 45 is adequately positioned in the Z-axis direction. In the same way, the top surface of the magnetic sensing portion 45 of the lower conversion IC 44 (left one in FIG. 10A) contacts with the bottom surface of the magnetic sensing portion 45 of the upper conversion IC 44 (right one in FIG. 10A) in order to position the magnetic sensing portion 45 of the upper conversion IC 44 in the Z-axis direction.

As shown in FIG. 10A, the conversion ICs 44 mounted on the lower mold K2 face each other in the horizontal direction (the X-axis direction) and their magnetic sensing portions 45 are overlapped in the vertical direction (the Z-axis direction). The positioning plates 45c of the conversion ICs 44 are arranged in the Z-axis direction (the vertical direction in FIG. 10A) due to the guide grooves K2M. Accordingly, each of the positioning plates 45c is disposed such that the impedance element (disposed at the center of the positioning plate 45c) is positioned on the rotation axis ZS. And, the computing portions 47 of the conversion ICs 44 are positioned parallel such that their bottom surfaces face each other in the X-axis direction (the horizontal direction in FIG. 10A) and are a predetermined distance apart from each other.

The lead terminals 48 extending from the computing portions 47 of the conversion ICs 44 are connected at their ends with the terminals 49 formed in the L-shape, respectively. Each of the terminals 49 has a first half extending in the Z-axis direction and connected with the lead terminal 48 and a second half extending away from the lower mold K2 in the X-axis direction.

The whole length of each conversion IC 44 (from one end of the magnetic sensing portion 45 to ends of the lead terminals 48) is small, in particular, about 20 mm. In a conventional manufacture method, an operator should fit the positioning plate 45c of the magnetic sensing portion 45 into a mounting position formed in a small and dim hole of a lower mold, so that such work requires great care and long time. On the other hand, in the manufacture method described above, the operator can fit the positioning plates 45c of the magnetic sensing portions 45 with the positioning grooves K2M formed on the upper end of the projection of the lower mold K2, that is, the closest position to the operator, so that it is able to very easily dispose the conversion ICs 44 on the lower mold K2. In addition, the operator can very easily cover the lower mold K2 with the upper mold K1. Therefore, working efficiency of this manufacture method is very higher than that of the conventional method.

As shown in FIG. 11A, the lower mold K2 provided with the conversion ICs 44 is covered with the upper mold K1 defining the cavity 52K such that the lower mold K2 is in the cavity 52K. Then, a resin is injected through an inlet In that is formed at an upper region of the upper mold K1 and communicates with the cavity 52K in order to fill the cavity 52K with the resin and form the molded body 52. The resin for the molded body 52 can be composed of a foamed resin containing a resin material (e.g., polybutylene terephthalate (PBT) resin) and a foaming agent, etc. During injection of the resin into the cavity 52K, the magnetic sensing portions 45 of the conversion ICs 44 are pressed toward the lower mold K2 due to a force F1 generated by injection of the resin, and the computing portions 47 of the conversion ICs 44 are pressed toward the lower mold K2 due to a force F2 also generated by injection of the resin, so that the conversion ICs 44 do not displace from its predefined position.

In accordance with this manufacture method, a first step is bending the leads 46 of each conversion IC 44 such that the bottom surface 45M of the magnetic sensing portion 45 is nearly perpendicular to the bottom surface 47M of the computing portion 47 (although the leads 46 can be bent in either S-shape or L-shape, the S-shape is more preferable). A second step is mounting a pair of the conversion ICs 44 on the lower mold K2 such that the magnetic sensing portions 45 of the conversion ICs 44 are positioned by the guide grooves K2M of the lower mold K2. A third step is covering the lower mold K2 provided with the conversion ICs 44 with the upper mold defining the cavity 52K such that the lower mold K2 and the conversion ICs 44 are disposed in the cavity 52K. A fourth step is injecting the resin into the cavity 52K in order to form the molded body 52 including the conversion ICs 44 therein.

The rotational angle sensor 40 ejected from the upper mold K1 and the lower mold K2 has an outer appearance shown in FIG. 4A-C (not including the interconnection terminals 54 in FIG. 4A) and a cross section shown in FIG. 11B. The molded body 52 is formed in the substantial cylinder shape. The conversion ICs 44, and connections between the terminals 49 and the lead terminals 48 extending from the computing portions 47 are buried in the molded body 52. The rotational angle sensor 40 defines the recess K2K formed by the lower mold K2. Preferably, the rotational angle sensor 40 is connected with the interconnection terminals 54 as shown in FIG. 3A, and then an electronic component can be inserted into the recess K2K and connected with the interconnection terminals 54. For example, a condenser for sensor denoising is inserted into the recess K2K and is connected to the interconnection terminals 54, the condenser can remove noise more effectively at a very close position to the conversion ICs 44. Furthermore, when the rotational angle sensor 40 is integrated with the sensor cover 30, the condenser does not interfere in actions of other components.

When the rotational angle sensor 40 is integrated with the sensor cover 30, the recess K2K is filled with a resin for the cover body 31. Because the molded body 52 of the rotational angle sensor 40 is formed by injecting the resin into the cavity K where a pair of the conversion ICs 44 are disposed as shown in FIG. 11A, the molded body 52 completely covers the conversion ICs 44 on a top surface (opposite to a bottom surface that the terminals 49 extend from) and a side surface (cylinder surface) of the molded body 52 such that the conversion ICs 44 are not exposed on the outside of the rotational angle sensor 40 on such surfaces. Accordingly, after integrating the rotational angle sensor 40 with the sensor cover 30 by insert molding as shown in FIG. 2, it is able to adequately preventingress of water or the like.

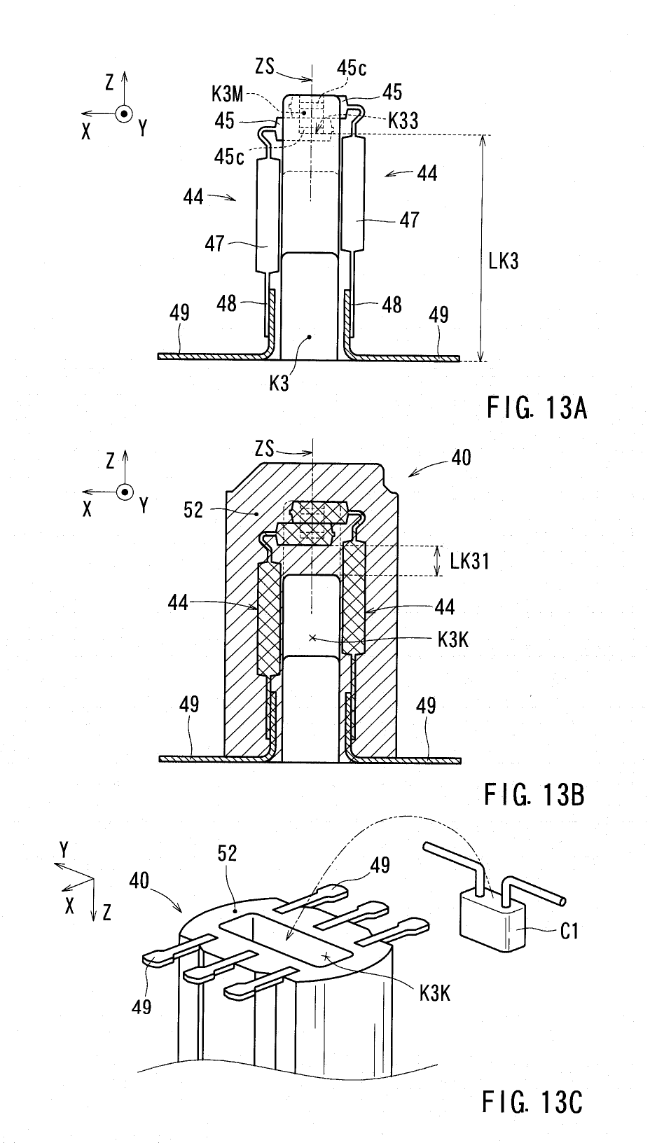

A second method for manufacturing the rotational angle sensor 40 will be described in reference to FIG. 12 and FIG. 13. The second manufacture method uses a lower mold K3 (FIG. 12A-C) different from the lower mold K2 of the first method (FIG. 9), and other configurations are same as those of the first method. Therefore, this difference will be mainly described. Firstly, an outer appearance of the lower mold K3 will be described in reference to FIG. 12A-C. FIG. 12A and FIG. 12B are a top view and a front view of the lower mold K3, respectively. FIG. 12C is a perspective view showing a step for mounting a pair of the conversion ICs 44 onto the lower mold K3.

The lower mold K3 is configured to form a recess K3K of the molded body 52 (refer to FIG. 13B) and has a projection extending upwardly. The lower mold K3 has at an upper end of the projection guide grooves K3M extending in the vertical direction (the Z-axis direction in FIG. 12C) for guiding the positioning plates 45c of the conversion ICs 44. The lower mold K3 of the second method is different from the lower mold K2 of the first method with respect to following two points. Each of the guide grooves K3M has a guide surface K33 at lower end thereof for contacting the positioning plate 45c in order to position the magnetic sensing portion 45 in the Z-axis direction. The lower mold K3 has a surface K34 substantially corresponding to the positioning surface K23 of the lower mold K2 in the first method such that the distance LK34 between the surface K34 and the lower end of the lower mold K3 in the Z-axis direction is shorter than the predetermined distance LK2 in the first method. In the lower mold K3, the guide surfaces K33 are positioned at a predetermined distance LK3 (different from the predetermined distance LK2 in the first method) from the lower end of the lower mold K3 in the Z-axis direction. The predetermined distance LK3 is used for positioning the magnetic sensing portions 45 of the conversion ICs 44, on the other hand, the distance LK34 between the surface K34 and the lower end of the lower mold K3 in the Z-axis direction is not used for positioning the magnetic sensing portions 45.

The rotational angle sensor 40 formed by the second method has a substantially same outer appearance as that manufactured by the first method. However, the rotational angle sensor 40 according to the second method additionally has a molded portion having a thickness LK31 between the magnetic sensing portion 45 and a bottom surface of the recess K3K (that is, a depth of the recess K3K is smaller than that of the recess K2K). Here, positions of the conversion ICs 44 in the rotational angle sensor 40 formed by the second method are same as those formed by the first method, and their detecting abilities are same as each other.

Next, advantages of the rotational angle sensor 40 of this embodiment will be described in reference to B-H loop (magnetic hysteresis loop) in FIG. 14. The B-H loop in FIG. 14 shows characteristics of a magnet. Its vertical axis indicates remanent magnetic flux density B (T), and its horizontal axis indicates magnetic field strength H (kA/m). For example, a cheap ferrite magnet shows a graph G2 at 20° C. and shows a graph G1 at −40° C. The graph G1 shows desirable characteristics where the magnetic field strength varies in a linear fashion depending on the remanent magnetic flux density in a region G1a, but shows undesirable characteristics where the magnetic field strength does not vary even though the remanent magnetic flux density varies in a region G1b. The graph G2 also shows desirable characteristics in a region G2a and undesirable characteristics in a region G2b. Compared with this, an expensive magnet containing rare metals or the like shows an improved graph G1 where the region G1b is modified as a dashed line G1S and an improved graph G2 where the region G2b is modified as a dashed line G2S.

For example, in a case that the permanent magnet has characteristics shown by the regions G1a and G1b (at −40° C.) and the regions G2a and G2b (20° C.), when using the conventional rotational angle sensor including the conversion ICs with L-shaped leads and the throttle gear defining the magnetic space having a diameter corresponding to the rotational angle sensor, its permeance coefficient is small and indicates, for example, a permeance line P2 in FIG. 14. In this case, the working point of the magnet at 20° C. is PZ (20) in the desirable region G2a, whereas, the working point of the magnet at −40° C. is PZ (−40) in the undesirable region G1b. Accordingly, there is a possibility that when the temperature changes from 20° C. to −40° C. and then returns to 20° C., the working point of the magnet does not return to PZ (20). Such change in characteristics causes decrease in the ability for detecting the rotation angle. Of course, there is no problem when using expensive magnets having characteristics including modified regions G1S and G2S. On the other hand, the rotational angle sensor 40 of this disclosure has the diameter D1 smaller than that of the conventional rotational angle sensor, so that the diameter D2 of the throttle gear 22 can be smaller and the distance between the permanent magnets 41 can become shorter. Thus, the slope of the permeance line can change to, for example, P1 in FIG. 14. In this case, the working point of the magnet at 20° C. is PA (20) in the desirable region G2a, and the working point of the magnet at −40° C. is PA (−40) in the desirable region G1a. Accordingly, when the temperature changes from 20° C. to −40° C., and then returns to 20° C., the working point returns to PA (20), so that the ability for detecting rotation angle does not decrease. Therefore, it is not necessary to use expensive magnets.

1. A rotational angle sensor comprising:
a molded body made of a resin and having a substantial cylinder shape with a center axis; and
a conversion IC buried in the molded body and having a magnetic sensing portion, a computing portion and leads connecting the magnetic sensing portion with the computing portion, wherein the magnetic sensing portion is disposed perpendicular to the center axis of the molded body, and the leads are bent such that the computing portion is disposed parallel to the axis of the molded body and that a connection between one of the lead and the computing portion is positioned closer to the center axis of the molded body than a radially outer end of the lead.

2. The rotational angle sensor according to claim 1, wherein
each of the leads has a curve section bent less than 90°.

3. The rotational angle sensor according to claim 1, wherein
each of the leads is bent in a substantial S-shape.

4. The rotational angle sensor according to claims 1, wherein
each of the leads has a first straight end near the magnetic sensing portion and a second straight end near the computing portion.

5. A method for manufacturing a rotational angle sensor including a molded body made of a resin, and a conversion IC buried in the molded body and having a magnetic sensing portion, a computing portion and leads connecting the magnetic sensing portion with the computing portion, the method comprising:
bending the leads such that the magnetic sensing portion is positioned nearly perpendicular to the computing portion;
mounting the conversion IC onto a lower mold having a projection with guide grooves such that the magnetic sensing portion fits with the guide grooves;
covering the lower mold with an upper mold defining a cavity such that the lower mold and the conversion IC are placed in the cavity; and
filling the cavity with a resin for the molded body.

6. The method for manufacturing the rotational angle sensor according to claim 5, wherein
the magnetic sensing portion has a positioning plate having opposed ends protruding from the magnetic sensing portion;
the lower mold has a positioning surface formed below the guide grooves; and
the mounting the conversion IC includes fitting the opposed ends of the positioning plate with the guide grooves and contacting the magnetic sensing portion with the positioning surface.

7. The method for manufacturing the rotational angle sensor according to claim 5, wherein
the magnetic sensing portion has a positioning plate having opposed ends protruding from the magnetic sensing portion;
the lower mold has guide surfaces formed at lower ends of the guide grooves; and
the mounting the conversion IC includes fitting the opposed ends of the positioning plate with the guide grooves and contacting the opposed ends of the positioning plate with the guide surfaces.

8. The method for manufacturing the rotational angle sensor according to claim 5, the method further comprising:
connecting the computing portion with terminals;
hardening the resin filled in the cavity in order to form the molded body defining a recess where the lower mold is disposed;
removing the lower mold from the molded body; and
disposing an electronic component in the recess and then connecting the electronic component with at least one of the terminals.
